(19) United States
(12) Patent Application Publication
(10) Pub. No.: US 2026/0286881 A1
(43) Pub. Date: Sep. 24, 2026

(54) COMPRESSION IGNITION ENGINE AND SYSTEM UTILIZING AMMONIA AS A FUEL SOURCE

(71) Applicant: Analytical Engineering, Inc., Columbus, IN (US)

(72) Inventors: David Francis May, Columbus, IN (US); Nicholas Hunter Karch, Columbus, IN (US); Katrina Ann Karch, Columbus, IN (US)

(73) Assignee: Analytical Engineering, Inc., Columbus, IN (US)

(21) Appl. No.: 19/381,060

(22) Filed: Nov. 6, 2025

Related U.S. Application Data
(60) Provisional application No. 63/718,176, filed on Nov. 8, 2024.

(51) Int. Cl. F02B 1/14; F01N 3/20; F01N 11/00; F02M 31/13

(52) U.S. Cl. CPC F02B 1/14; F01N 3/2066; F01N 11/007; F02M 31/13; F01N 2610/02; F01N 2900/1402

(57) ABSTRACT

A compression ignition engine system includes: a compression ignition engine, which is configured for using ammonia as a primary fuel source and a compression ignition engine fuel as a secondary fuel source; and an exhaust system coupled with the compression ignition engine, the exhaust system having an absence of an exhaust gas recirculation system or an absence of an exhaust gas recirculation system that functions.

### CROSS REFERENCE TO RELATED APPLICATIONS

This is a non-provisional application based upon U.S. provisional patent application Ser. No. 63/718,176, entitled “COMPRESSION IGNITION ENGINE AND SYSTEM UTILIZING AMMONIA AS A FUEL SOURCE”, filed Nov. 8, 2024, which is incorporated herein by reference.

### BACKGROUND OF THE INVENTION

### 1. Field of the Invention

The present invention relates to engine systems, and, more particularly, to compression ignition engine systems.

### 2. Description of the Related Art

Global greenhouse emissions from stationary and mobile diesel, gasoline, ethanol and natural gas engines are major contributors to the accumulation of carbon dioxide in the earth's atmosphere resulting in global warming. Recent advances in renewable energy sources shows some promise to reduce these effects, however it is impossible to implement these sorts of improvements in a timely manner. The ratio of wind, solar and similar energy sources to that of combustion engine energy sources is a microcosm and will not be a major source of mechanical and/or electrical energy for the world in the next few decades.

Diesel engines in North America contribute 10% of the total U.S. energy-related CO2 emissions. Combustion of any hydrocarbon fuel will result in a continuation of this contribution. There exists a large need for engines that can replace hydrocarbon burning engines with a non-carbon combustible fuel. If done properly, the energy which is otherwise generated by burning hydrocarbon based fuels can be similarly accomplished with a non-carbon based fuel with minimal carbon dioxide generation and thus minimal global warming impact.

What is needed in the art is a compression ignition engine system that uses non-carbon based fuel as much as possible.

### SUMMARY OF THE INVENTION

The present invention provides a compression ignition engine system that uses ammonia as fuel and some compression ignition engine fuel, the compression ignition engine system lacking an exhaust gas recirculation system or an exhaust gas recirculation system that functions.

The invention in one form is directed to a compression ignition engine system including: a compression ignition engine, which is configured for using ammonia as a primary fuel source and a compression ignition engine fuel as a secondary fuel source; and an exhaust system coupled with the compression ignition engine, the exhaust system having an absence of an exhaust gas recirculation system or an absence of an exhaust gas recirculation system that functions.

The invention in another form is directed to a method of forming and using a compression ignition engine system, the method including the steps of: providing that the compression ignition engine system includes a compression ignition engine, which is configured for using ammonia as a primary fuel source and a compression ignition engine fuel as a secondary fuel source; and coupling an exhaust system with the compression ignition engine, the exhaust system having an absence of an exhaust gas recirculation system or an absence of an exhaust gas recirculation system that functions.

An advantage of the present invention is the use of a fuel, ammonia, that burns cleanly, without particulate matter or carbon dioxide.

Another advantage is the ability to convert an existing compression ignition engine system to a compression ignition engine system according to the present invention.

Yet another advantage is the lack of need for an Exhaust Gas Recirculation system, Diesel Oxidation Catalyst, Diesel Particulate Filter, or Urea Injection System.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a compression ignition engine system, including a compression ignition engine, an intake system, and an exhaust system, in accordance with an exemplary embodiment of the present invention;

FIG. 2 is a schematic representation of another embodiment of a compression ignition engine system, with portions broken away, in accordance with an exemplary embodiment of the present invention;

FIG. 3 is a schematic representation of yet another embodiment of a compression ignition engine system, with portions broken away, in accordance with an exemplary embodiment of the present invention; and

FIG. 4 is a flow diagram of a method of forming and using a compression ignition engine system, in accordance with an exemplary embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

According to an exemplary embodiment of the present invention, the present invention provides a compression ignition engine system that includes a compression ignition engine that uses ammonia as the primary fuel and a compression ignition engine fuel as the secondary fuel. The compression ignition engine can be, for example, a compression ignition, conventional, modern diesel engine that is modified to burn ammonia as the primary fuel and the compression ignition engine fuel as the secondary fuel. Significantly, the engine of the present invention is a compression ignition engine—whether specifically a diesel engine or some other suitable compression ignition engine—that uses any suitable compression ignition engine fuel, such as (by way of example and not limitation) diesel fuel, a biodiesel fuel (any blend of biodiesel or 100% biodiesel), hydrogenated vegetable oil (HVO) (any blend of HVO or 100% HVO), any drop-in replacement for diesel fuel, any hydrocarbon-based fuel with cetane number or other thermophysical properties enabling or sufficient to support compression ignition, or any blend of traditional diesel fuel with biodiesel fuel, HVO, or any hydrocarbon-based fuel with cetane number or other thermophysical properties enabling or sufficient to support compression ignition, or blends thereof; the type of compression ignition engine typically referenced herein is a diesel engine and thus the type of fuel typically referenced herein is diesel fuel, but this is done by way of example and not limitation. Ammonia is a highly combustible gas at standard conditions and contains no carbon. Ammonia, or NH3, is a fuel that can be used resulting in the generation of gases including water vapor, nitrogen and, in some cases, some oxygen. As will be discussed in subsequent sections, there are other gases that can be generated including nitrogen oxide (NO), nitrogen dioxide (NO2), nitrous oxide (N2O), and unburnt or otherwise generated ammonia (NH3).

The present invention relies on the use of a very small amount of compression ignition engine fuel, i.e., diesel fuel, (the secondary fuel, according to the present invention) during the combustion cycle in addition to the primary fuel, ammonia. Therefore, there is a small amount of carbon dioxide that is generated with this technique, however the benefits of burning ammonia outweigh the negative aspects of burning some, albeit a small amount, of hydrocarbon fuel.

This can be accomplished with practically any modern diesel engine, for legal applications for both on-road and non-road use.

The present invention uses pilot injection of diesel fuel into a compression ignition regime whereby the compression ignited fuel subsequently ignites the homogenously inducted, or direct injected, ammonia resulting in similar power densities found with normal compression and spark ignited engines. This methodology results in an engine that mimics a conventional diesel engine in terms of transient response, power density, sound, feel, thermal efficiency, and operator or driver acceptance.

According to an exemplary embodiment of the present invention, there are no modifications to the combustion chamber, power cylinder components, and diesel fuel injection mechanical system. The simplicity of the overall system is, in large part, a fundamentally attractive aspect of the overall invention.

In one embodiment, a stock 2018 vintage Cummins 15 liter ISX engine is used with no previous modifications. The engine is on a stand and is coupled to an AC motoring dynamometer (“dyno”) by way of a drive shaft. The dyno currently in use is a 1000 hp machine capable of 4000 rpm max.

The exit of the compressor side of a turbocharger, of the compression ignition engine system, is connected to a steel tube that is directed around the front of the engine and directly into the intake manifold. In addition to instrumentation ports on the tube, a ½ inch NPT half coupling is welded to the tube substantially near the exit of the turbo compressor (of the turbocharger). Currently, a ¾ inch tube is connected to this half coupling that conveys the gaseous ammonia for induction. As ammonia is delivered to this location, it mixes with the compressed air from the turbo (the turbocharger) before it is delivered to the intake manifold. This method ensures reasonably homogenous mixing of the air and ammonia before the mixture enters into each of the six intake ports.

The gaseous ammonia is currently sourced from an ammonia storage tank which is located outside the building behind the test cell. A one-inch stainless steel transfer tube is routed through the building to the test cell with appropriate shut off valves, pressure measurement transducers, thermocouples, etc., before it enters the test cell. Once in the cell, tubing is connected to a proportional valve that can be electronically (digital) actuated to vary the flow of the gaseous ammonia. Another tube connects the exit of the valve to a Coriolis Effect mass flow measurement meter. This meter provides an instantaneous and continuous digital value of the mass flow of the ammonia passing through it and subsequently into the aforementioned crossover tube between the turbo compressor and the intake manifold of the engine. By manipulating the position of the control valve, the mass flow of ammonia into the engine during operation can be accurately measured and controlled.

This method of controlling the ammonia induction rate could also be accomplished with a mass flow controller.

Through experimentation over a period of time, it was observed that:
1. The controlled induction of the ammonia is easily achieved.
2. By starting the engine by conventional means, i.e, using the normal diesel fuel injection system and nominal engine starting controls (base engine calibration), engine starting is substantially similar to a normal modern diesel engine start.
3. Once the engine has started, ammonia can be added to achieve the optimum ratio of diesel to ammonia to subsequently achieve stable combustion, idle speed control, etc.
4. Ammonia can be added at all nominal speed ranges from 600 to 2100 rpm.
5. Ammonia can be added at virtually all power settings from idle to rated power.
6. As the engine is operated at all nominal speeds and loads, the ammonia to diesel mass flow ratio can be varied over a wide range.
7. At some operating points, the diesel pilot injection quantity can be reduced to as little as 5% diesel energy share (the 5% threshold is exemplary and could be higher or lower (i.e., 1-20%)). The diesel energy share is defined as the fraction of fuel energy provided by the diesel, divided by the total fuel energy injected.

$$diesel energy share = \frac{diesel fuel rate ( \frac{kg}{hr} ) * diesel LHV ( \frac{MJ}{kg} )}{\begin{matrix}diesel fuel rate ( \frac{kg}{hr} ) * diesel LHV ( \frac{MJ}{kg} ) + \\ ammonia fuel rate ( \frac{kg}{hr} ) * ammonia LHV ( \frac{MJ}{kg} )\end{matrix}} \qquad a .$$

8. For the initial experiment, the throttle (voltage) input to the diesel engine ECM (engine control module) is used to control the diesel fueling rate, since diesel fuel rate is directly tied to throttle position on a traditional diesel engine. The ammonia fuel rate is controlled with the previously mentioned valve and flow meter combination in the test cell. On-board calculations at the test cell computer calculate real-time the ammonia and diesel fuel energy share, knowing both the ammonia and diesel fuel rate, and their LHV (lower heating value). The resultant emissions from this type of work specific to carbon dioxide has been shown to be what inventors would expect, namely, CO2 emissions reduction equivalent to the reduction in diesel fuel energy compared to 100% diesel fuel operation.
9. By controlling the variable geometry turbocharger, the air fuel-to-ratio of the overall system can be easily and effectively controlled.
10. Combustion of the diesel and ammonia mixture can be maintained across a wide range of air-to-fuel ratios (AFR).
11. The overall fuel efficiency of the engine can be affected by controlling the AFR, among other things.
12. The resultant emissions of the engine vary widely as a function of controlling the AFR. Specifically, emissions of NO, NO2, N20, and ammonia can be controlled by varying engine speed, torque, AFR, diesel-energy share, among other things.
13. There is no apparent advantage to using Exhaust Gas Recirculation (EGR) (EGR is a system that recirculates a portion of an engine's exhaust gas back into the combustion chamber to lower peak combustion temperatures, which in turn reduces the formation of harmful nitrogen oxides (NOX)). The EGR system can be removed from the engine architecture altogether (an exemplary embodiment of the present invention provides that the EGR system has been removed or is rendered nonfunctioning). This will result in a substantial cost reduction as well as provide considerable improvements in terms of reliability, weight, and degraded performance. Thus, according to an embodiment of the present invention, the EGR system of the compression ignition engine system is removed. According to an alternative embodiment of the present invention, the EGR system is rendered nonfunctioning; that is, the EGR system exists (in whole or in part) but it does not function, because the EGR system has been made not to function, either permanently (that is, the EGR system cannot be made to function again) or temporarily (that is, the EGR system could be made to function again). In being made not to function, the EGR system can (by way of example and not limitation) have a passageway that is plugged so that exhaust gas cannot proceed therethrough, or a controller can be set so that the EGR system is not used as intended.
14. According to this embodiment of the present invention, the compression ignition engine system is operated without a charge air cooler (CAC). There does not appear to be an advantage in using a CAC; thus it can also be removed from the engine architecture. This is another significant cost reduction and provides for improvement in reliability, weight, and packaging constraints as well as improvements in pumping losses, thus improving efficiency.
15. There is no need for an EGR control valve, flow measurement (venturi or other), EGR cooler, or other subcomponents for the EGR subsystem, due to the fact that EGR does not provide an improvement in combustion efficiency or a reduction in engine out emissions that warrants its additional cost and complexity.
16. Based on observations, there is no need for an induction air throttle, as the induction air throttle's primary use is to allow for the inflow of EGR into the intake manifold, and as previously mentioned, EGR is not needed.

The emissions from this engine is a primary advantage of the present invention. Ultimately, it would be beneficial to have an engine that has roughly equivalent thermal efficiency to that of a conventional modern diesel engine with nominally similar emissions of NO, NO2, hydrocarbons, and particulate. These emittants are currently regulated by the USEPA for North American applications and by several other entities for applications in other countries.

In current diesel engines with aftertreatment systems, NO and NO2 are controlled with in-cylinder reduction recipes based on hardware and controls. Then, they are subsequently controlled primarily by reacting these gases with degradation products from urea, notably ammonia. Additionally, most manufacturers employ the use of an oxidation catalyst either as the first element in the system or the second. This catalyst reduces unburnt hydrocarbons and can raise the inlet temperature of a downstream particulate trap. The combination of these devices allows for near net zero emissions of NO, NO2, ammonia, hydrocarbons, and particulate.

The use of ammonia to react with NO and NO2 is an advantage because significant amounts of ammonia gas are usually observed in the exhaust emissions. This is referred to as ammonia slip. Basically, it is ammonia that was not consumed (burnt) in the combustion cycle. It can also be ammonia that is formed late in the cycle from intermediate molecules that are formed during combustion. Inventors also see significant concentrations of NO and NO2. Inventors have used a catalyst section that is normally used in diesel engine aftertreatment systems referred to as the selective catalytic reduction catalyst (SCR). Diesel platforms induce urea upstream of the SCR where the thermal degradation results in ammonia gas production. This reacts with the NO and NO2 in the SCR resulting in the formation of water, N2, and CO2.

By effectively inducing slipped ammonia directly into the SCR along with mixed NO and NO2, the present invention advantageously provides the same result, moreover without the CO2. By controlling the engine operating conditions, the relative and absolute amounts of NO, NO2, and ammonia can be controlled; thus zero ammonia and NOx (oxides of nitrogen, including NO and NO2) emissions downstream of our catalyst can be achieved.

Inventors experimented to understand the particulate emissions of their prototype engine. Based on preliminary observations, there were little to no particulate emissions. Therefore, Inventors advantageously have expected that there is no need for a particulate trap, currently referred to as a diesel particulate filter or trap or DPF.

Inventors did observe some N2O emissions. Additional N2O emissions were observed when there was a diesel oxidation catalyst (DOC) upstream of the SCR. In this case, the DOC is partially oxidizing the slipped ammonia to N2O. As a result, Inventors moved the DOC downstream of the SCR, according to an embodiment of the present invention. Excellent conversion of the NOx with ammonia in the SCR has been observed.

According to an embodiment of the present invention, based on findings the aftertreatment system for the compression ignition engine system includes the following consecutive elements.
1. An SCR as the first element. This provides the simultaneous reduction of slipped ammonia and NOx.
2. An N2O reduction catalyst. This eliminates the emission of N2O.

The current EPA mandated limit on N2O is 0.1 gram per HP-Hr. The present invention may provide for being significantly below that without the need for a N2O catalyst.

If an N2O catalyst is used according to the present invention, the catalyst will be based on a copper matrix on a zeolite substrate which is inexpensive and plentiful.

SCR's and copper-based zeolite catalysts are inexpensive. As a result, the overall cost of this engine to manufacture and to meet EPA mandated limits for diesel engines, according to an embodiment of the present invention, is significantly lower than that of a modern legal engine and aftertreatment combination. In general terms, the engine can be built for about ⅔ of the cost of a new engine today. The aftertreatment system is far less complex than that of conventional new ones and does not need noble metals for effectiveness, thus the cost of the ammonia-based aftertreatment should be ¼ the cost of current systems.

Induction of liquid ammonia into the engine induction system, according to an embodiment of the present invention, provides a large improvement in precise control of the ammonia induction flow rate. This can be accomplished by removing the mass flow control system and installing a very simple liquid injector into the crossover tube in the same location that gaseous ammonia is induced, according to that embodiment of the present invention (the embodiment that induces gaseous ammonia). The injector can be substantially similar to a conventional gasoline-port injector. These injectors are available, inexpensive, compatible with liquid ammonia, and reliable.

Air that is compressed by the turbocharger exits at elevated temperatures. This is an advantage, because the evaporation of ammonia into the crossover tube produces significant evaporative cooling. This allows for no CAC and good ammonia mixing. For liquid ammonia injection, intake manifold heating is required to combat a large cooling effect.

According to an embodiment of the present invention, since the present invention is largely less complicated than existing modern diesel engines and utilizes modern diesel engine's existing equipment, a retrofit of existing diesel engines in the marketplace is possible. Below is a list of steps/requirements to retrofit an existing diesel engine in a truck or power generator application:
1. Upfit of ammonia storage tank and feed line to transfer ammonia from tank to ammonia injector.
2. Upfit of ammonia injector onto an existing engine. This can be done in a number of ways, i.e., by swapping to an intake manifold that has provisions for mounting of an ammonia injector, drilling/tapping an existing intake manifold, or replacing charge piping with pipes that have provisions for injector mounting.
3. Download new ECM calibration.
4. Install new exhaust aftertreatment+additional ammonia sensors in the exhaust stream.
5. Optional-remove charge air cooler.
6. Optional-remove/plug EGR system (or force EGR to 0 with ECM).
7. Optional-remove urea storage and injection system.
8. Install new wiring harness for new injector/sensors.

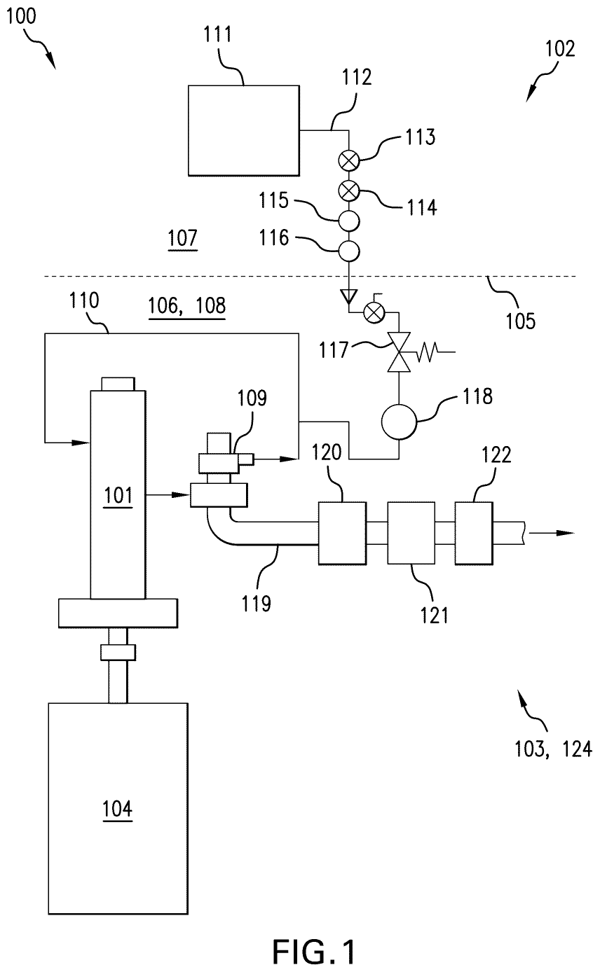

Referring now to FIG. 1, there is shown schematically a compression ignition engine system 100, including a compression ignition engine (a diesel engine) 101, an intake system 102, and an exhaust system 103. System 100 is shown further to include a dynamometer (a dyno) 104 for testing purposes, dyno 104, as is known, being configured for measuring torque and rotational speed (rpm) of engine 101. System 100 is, in FIG. 1, in a test environment that a wall 105 separating an inside area 106 from an outside area 107, inside area 106 including a test cell 108 in which portions of system 100 are shown to be located.

Intake system 102 is coupled with engine 101 and includes a turbocharger 109 (including a turbine and a compressor; the turbine could be deemed to be a part of exhaust system but, for simplicity, is deemed to be part of intake system herein), such as a variable geometry turbocharger, and an intake conduit 110 (a passageway) running from the compressor of turbocharger 109 to an intake manifold of engine 101, intake conduit 110 being configured for communicating air and, as necessary, ammonia to engine 101. Intake system 102 is shown to further include a storage tank 111 (which can store ammonia in liquid or gaseous (vapor) form, though the design of system 100 shown in FIG. 1 is intended as an ammonia vapor induction system), a conduit 112 running from storage tank 111 to intake conduit 110, a manual shutoff valve 113, an electrically actuated valve 114, a pressure transducer 115, a thermocouple 116, an electronic proportional valve 117, and a flow meter 118. Exhaust system 103 is coupled with engine 101 and includes an exhaust conduit 119 (a passageway) carrying an exhaust stream (such as exhaust gas) away from engine 101, away from the turbine of turbocharger 109, and, in the direction of the exhaust stream flow, to an SCR 120, a DOC 121, and an N2O reduction catalyst 122 (which is optional) and further beyond to be discharged into the surrounding atmospheric air. Exhaust system 103 thus includes an aftertreatment system 124 that includes any suitable devices, such as an SCR, a DOC, an N2O reduction catalyst, or the like. Thus, in use, ammonia (such as vapor ammonia) is communicated from storage tank 111 through conduit 112 to intake conduit 110 where ammonia meets air flowing from the compressor of turbocharger 109, the air and ammonia mixture then flowing through intake conduit 110 to the intake manifold of engine 101 and onward to a combustion chamber of engine 101.

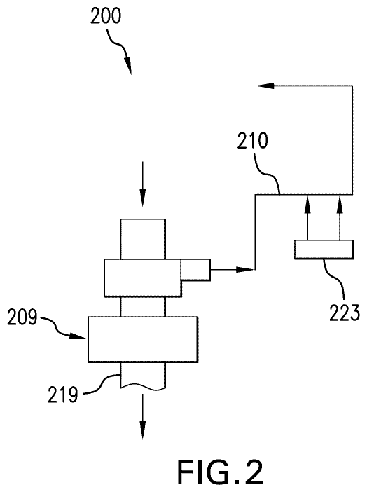

Referring now to FIG. 2, there is shown schematically a compression ignition engine system 200, according to another exemplary embodiment of the present invention, with portions broken away relative to FIG. 1. Structures of system 200 that are substantially similar in structure and function to structures of system 100 are raised by a multiple of 100, unless stated otherwise. System 200 includes turbocharger 209, exhaust conduit 219 running from the turbine of turbocharger 209, and intake conduit 210 running from the compressor of turbocharger 209 to the intake manifold of the compression ignition engine (not shown in FIG. 2). While system 100 is design for gaseous ammonia induction, system 200 is designed for liquid ammonia induction. To that end, system 200 includes liquid ammonia injectors 223 configured for injecting liquid ammonia into intake conduit 210 (which can be referred to as a crossover tube). Thus, system 200 can further include storage tank 111 (not shown in FIG. 2) that feeds liquid ammonia to injectors 223 by way of a feed line (not shown), which may have coupled therewith manual shutoff valve 113, electrically actuated valve 114, pressure transducer 115, thermocouple 116, electronic proportional valve 117, and flow meter 118 (none of which are shown in FIG. 2), or structures similar thereto. Thus, in use, liquid ammonia is communicated from the storage tank through the feed line to intake conduit 210 via injectors 223 where ammonia meets air flowing from the compressor of turbocharger 209, the air and ammonia mixture then flowing through intake conduit 210 to the intake manifold of the compression ignition engine and onward to the combustion chamber of the combustion ignition engine.

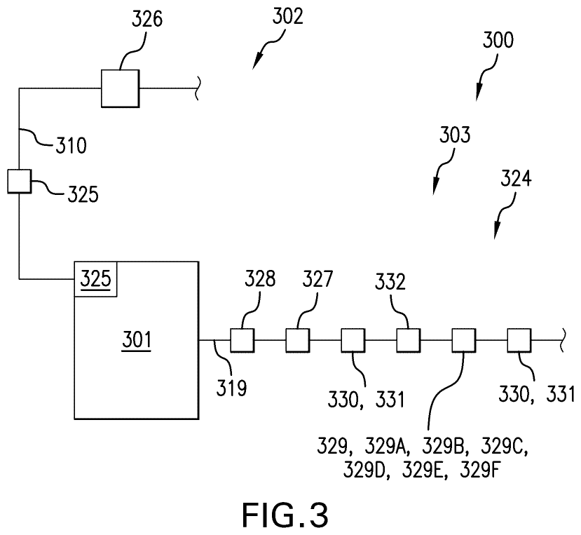

Referring now to FIG. 3, there is shown schematically a compression ignition engine system 300, according to another exemplary embodiment of the present invention, with portions broken away relative to FIG. 1. Structures of system 300 that are substantially similar in structure and function to structures of system 100 are raised by a multiple of 100 (unless stated otherwise), though system 300 can be used with liquid or gaseous ammonia. System 300 includes compression ignition engine 301, intake system 302 (which includes intake conduit 310), and exhaust system 303 (which includes exhaust conduit 319 and aftertreatment system 324, which may have different structures than aftertreatment system 124). System 300 (in particular, intake system 302) includes a structure 325 for heating intake air used by engine 301, structure 325 being a heat exchanger or an electric heater. Structure 325 can be a part of or attached to an intake manifold of engine 301 or can be associated with intake conduit 310, or system 300 can have a plurality of structures 325 which can be located in either position. Structure 325 can be, for example, a heat exchanger using waste heat from coolant, oil, or exhaust gas or can be an electrical heater, or any other suitable device. Further, system 300 includes a structure 326 configured for modifying an air-fuel ratio, structure 326 being, for example, a variable geometry turbocharger, a wastegate, an intake throttle (which can be referred to as a throttle body), an exhaust throttle valve (specifically numbered as 327 in FIG. 3 but can be subsumed under 326), or other suitable device. Further, exhaust system 303 can include an oxygen sensor 328 configured for sensing oxygen in an exhaust stream in order to control an air-fuel ratio (oxygen sensor 942 can be located in any suitable location in exhaust stream). Further, exhaust system 303 can include at least one emission reduction device 329 and sensors 330, 331 upstream and/or downstream of the at least one emission reduction device 329, sensors 330 being NOx sensors and sensors 331 being ammonia sensors (sensors 330, 331 downstream of the at least one emission reduction device 329 are downstream of at least SCR 120, alternatively of SCR 120 and another emission reduction device 329, alternatively of all emission reduction devices 329). Further, exhaust system 303 can include an ammonia injection device 332 configured for injecting ammonia into the exhaust stream, so as to supply ammonia to an SCR (which can be a device 329) in order to control emissions. Further, exhaust system 303 can include one or more emission reduction devices 329 (if a plurality of devices 329 are used, these devices can be different from one another and spaced apart from one another along exhaust conduit 329), including: (a) an SCR 329A; (b) an SCR 329A, followed by an Ammonia Oxidation Catalyst (AMOX) 329E; (c) an SCR 329A or a combination of an SCR and an AMOX (SCR/AMOX combination 329B), followed by a DOC 329C; (d) an SCR 329A or an SCR/AMOX combination 329B, followed by a DOC 329C and then a DPF 329D; or (e) an N2O reduction catalyst 329F in any of (a)-(d) but after SCR 329A.

Accordingly, in general, the present invention provides a compression ignition engine system 100, 200, 300 (i.e., a diesel engine system) that runs on primarily ammonia fuel and secondarily on some compression ignition engine (i.e., diesel) fuel. According to an embodiment of the present invention, a conventional compression ignition engine system 100, 200, 300 can be converted to run on primarily ammonia fuel and secondarily on some diesel fuel; alternatively, according to another embodiment of the present invention, rather than being so converted, the compression ignition engine system 100, 200, 300 can be manufactured to run on primarily ammonia fuel and secondarily on some diesel fuel. The former is assumed in the following unless stated or suggested otherwise. Thus, the compression ignition engine system 100, 200, 300 is externally modified for introduction of gaseous or liquid ammonia upstream of the intake ports of the diesel engine 101, 301. Further, the present invention provides that the compression ignition engine system 300 can optionally further include structure 325 configured for raising the temperature of intake air and structure 326 configured for reducing the air-fuel ratio (AFR) (for example, using a wastegate, which is a valve—controlling exhaust gas to a turbine of a turbocharger—in a turbocharged system that can be understood to control boost pressure by diverting exhaust gases to bypass the turbine wheel when a predetermined pressure is reached). The aftertreatment system 124, 324 of the compression ignition engine system 100, 200, 300 is modified to eliminate the EGR system (at least the functionality thereof). Further, the aftertreatment system 124, 324 can optionally be modified to eliminate the DOC 121, 329C and the DPF 329D or to move the DOC 121, 329C and the DPF 329D to after the SCR 120, 329A.

As indicated, according to the present invention, the compression ignition engine system 100, 200, 300 can have structure(s) 325, 326 to modify the intake manifold temperature and the air-fuel ratio. Regarding the intake manifold temperature being modified, the intake manifold temperature can be heated by coolant, oil, or exhaust gas heat, such as by way of a heat exchanger, or by way of an electric heater, for example. Thus, for instance, liquid ammonia can be vaporized by a heat exchanger using waste heat from coolant, oil, or exhaust gas or by any other intake manifold heating device. Regarding the air-fuel ratio being modified, the air-fuel ratio can be controlled to as low as near stoichiometric (Lambda 1-2) at certain operating conditions via a variable geometry turbocharger, a wastegate, an intake throttle, an exhaust throttle, any combination thereof, or other ways.

Further, according to additional embodiments of the present invention, the compression ignition engine system 100, 200, 300 may have one or more of the following:
1. Emissions reduction devices 329 (as part of the aftertreatment system 124, 324), which may include:
   a. an SCR 120, 329A;
   b. an SCR 120, 329A, followed by an AMOX (ammonia oxidation catalyst) 329E;
   c. an SCR 120, 329A or an SCR/AMOX combination 329B, followed by a DOC 121, 329C;
   d. an SCR 120, 329A or an SCR/AMOX combination 329B, followed by a DOC 121, 329C and then a DPF 329D; or
   e. an N2O reduction catalyst 329F in any of (a)-(d) but after SCR 120, 329A.
2. NOx and ammonia sensors 330, 331 upstream and downstream of the emissions reduction devices 329.
3. Heating of the charge air by way of electricity, either in addition to or in place of heating the charge air through waste heat of coolant, oil, or exhaust.
4. Air-to-air charge air cooler (CAC) removed or bypassed.
5. An ammonia injection device 332 (separate from ammonia injection into the intake of the diesel engine), where ammonia injection into the exhaust occurs in order to control emissions during diesel-only mode, or dual-fuel mode, to supply ammonia for the SCR 120, 329A.
6. A vapor ammonia injection system (as an alternative to a liquid ammonia injection system), where heating of the intake air through waste heat and/or electrical heat may or may not be implemented, but where charge air cooling would be removed.
7. An O2 sensor 328 in the exhaust system to sense oxygen in the exhaust gas, for closed loop control of the air-fuel ratio or for monitoring the air-fuel ratio, where the controlled value would be much lower than typical on a conventional diesel engine system. The controlled value is a targeted air-fuel ratio (which can be a wide range and is based on the engine's (101, 301) operating point), where the O2 sensor 328 provides a measured air-fuel ratio as feedback to a controller controlling the air-fuel ratio, which can be as low as Lambda of 1.
8. The compression ignition engine 101, 301 may use the former EGR pathway from the exhaust manifold (of the compression ignition engine) as a wastegate path (if the engine originally had an EGR).

In use, ammonia and air, and diesel fuel as necessary, is communicated to the combustion chamber of engine 301. Heater 325 can be used to heat the air and/or ammonia in intake conduit 110, 210, 310 and/or in the intake manifold of engine 101, 201, 301, and/or structure 326 can be used to control the air-fuel ratio. Further, after combustion, the exhaust stream is used in connection with a turbocharger and/or proceeds through exhaust conduit 119, 219, 319 to an outlet to atmospheric air, after encountering oxygen sensor 328, exhaust throttle valve 327, sensors 330, 331, ammonia injector(s) 332, and/or emission reduction devices 329.

In summary, a compression ignition engine system 100, 200, 300 includes: a compression ignition engine 101, 301, which is configured for using ammonia as a primary fuel source and a compression ignition engine fuel as a secondary fuel source; and an exhaust system 103, 303 coupled with the compression ignition engine 101, 301, exhaust system 101, 301 of the compression ignition engine system 100, 200, 300 including an absence of an EGR system or an EGR system that functions. Further, optionally, compression ignition engine system 100, 200, 300 includes an intake conduit 110, 210, 310 coupled with the compression ignition engine 101, 301, wherein the ammonia is a liquid or a gas when the ammonia is introduced into the intake conduit 110, 210, 310. Further, optionally, compression ignition engine system 100, 200, 300 includes a first structure 325 configured for heating an intake air used by compression ignition engine 101, 301, wherein first structure 325 is a heat exchanger or an electric heater. Further, optionally, compression ignition engine system 100, 200, 300 includes a second structure 326 configured for modifying an air-fuel ratio, wherein the fuel includes the ammonia. Further, optionally, compression ignition engine system 100, 200, 300 has an absence of an air-to-air charge air cooler or includes an air-to-air charge air cooler that is bypassed by a charge air. Further, optionally, exhaust system 103, 303 includes at least one emission reduction device 329 and a plurality of sensors 330, 331, the plurality of sensors 330, 331 including a first NOx sensor 330, a first ammonia sensor 331, a second NOx sensor 330, and a second ammonia sensor 331, the first NOx sensor 330 and the first ammonia sensor 331 being positioned upstream of the at least one emission reduction device 329, and the second NOx sensor 330 and the second ammonia sensor 331 being positioned downstream of the at least one emission reduction device 329. More broadly (and thus alternatively), the plurality of sensors 330, 331 include at least one sensor 330, 331 positioned upstream of the at least one emission reduction device 329 and at least one sensor 330, 331 positioned downstream of the at least one emission reduction device 329, the at least one sensor 330, 331 positioned upstream of the at least one emission reduction device 329 being NOx sensor 330 or ammonia sensor 331, the at least one sensor 330, 331 positioned downstream of the at least one emission reduction device 329 being NOx sensor 330 or ammonia sensor 331; for example (and not limitation), the plurality of sensors 330, 331 may lack the ammonia sensor 331 positioned upstream of the at least one emission reduction device 329 but have the NOx sensor 330 positioned upstream of the at least one emission reduction device 329 and the NOx sensor 330 and the ammonia sensor 331 positioned downstream of the at least one emission reduction device 329. Further, optionally, exhaust system 103, 303 includes an ammonia injection device 332 configured for injecting ammonia into an exhaust stream. Further, optionally, exhaust system 103, 303 includes an oxygen sensor 328 for sensing oxygen in an exhaust stream in order to control or sense an air-fuel ratio. Further, optionally, exhaust system 103, 303 includes: (a) a Selective Catalytic Reduction catalyst (SCR) 120, 329A, and thus the exhaust system has an absence of Diesel Oxidation Catalyst (DOC) and a Diesel Particulate Filter (DPF); (b) an SCR 120, 329A, followed by an Ammonia Oxidation Catalyst (AMOX) 329E; (c) an SCR 120, 329A or an SCR/AMOX combination 329B, followed by a DOC 329C; (d) an SCR 120, 329A or an SCR/AMOX combination 329B, followed by a DOC 329C and then a DPF 329D; or (e) an N2O reduction catalyst 329F in any of (a)-(d) but after the SCR 120, 329A. Further, optionally, compression ignition engine system 100, 200, 300 includes an absence of a charge-air cooler (between a turbocharger and an air intake manifold), an absence of an EGR system, an absence of a diesel particulate filter, an SCR, a DOC, and is configured to use slip ammonia in the SCR filter.

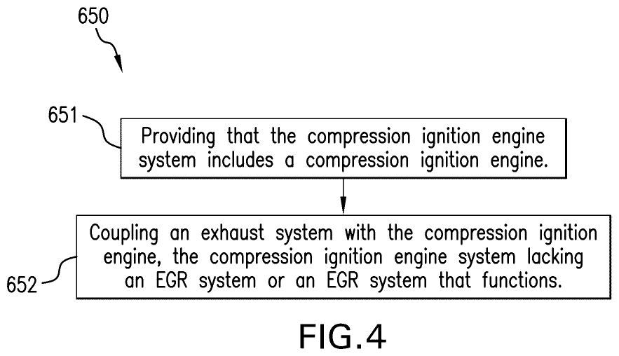

Referring now to FIG. 4, there is shown a flow diagram of a method 400 of forming and using a compression ignition engine system 100, 200, 300. Method 400 includes the steps of: providing 651 that the compression ignition engine system 100, 200, 300 includes a compression ignition engine 101, 301, which is configured for using ammonia as a primary fuel source and a compression ignition engine fuel as a secondary fuel source; and coupling 652 an exhaust system 103, 303 with the compression ignition engine 101, 301, the compression ignition engine system 100, 200, 300 having an absence of an exhaust gas recirculation system or an absence of an exhaust gas recirculation system that functions. Further, optionally, the compression ignition engine system 100, 200, 300 includes an intake conduit 110, 210, 310 coupled with the compression ignition engine 101, 301, wherein the ammonia is a liquid or a gas when the ammonia is introduced into the intake conduit 110, 210, 310. Further, optionally, compression ignition engine system 100, 200, 300 further includes a first structure 325 configured for heating an intake air used by the compression ignition engine 101, 301, wherein the first structure 325 is a heat exchanger or an electric heater. Further, optionally, compression ignition engine system 100, 200, 300 further includes a second structure 326 configured for modifying an air-fuel ratio, wherein the fuel included ammonia, which may be zero or greater than zero. Further, optionally, compression ignition engine system 100, 200, 300 has an absence of an air-to-air charge air cooler or includes an air-to-air charge air cooler that is bypassed by a charge air. Further, optionally, exhaust system 103, 303 includes at least one emission reduction device 329 and a plurality of sensors 330, 331, the plurality of sensors 330, 331 including at least one sensor 330, 331 positioned upstream of the at least one emission reduction device 329 and at least one sensor 330, 331 positioned downstream of the at least one emission reduction device 329, the at least one sensor 330, 331 positioned upstream of the at least one emission reduction device 329 being a first NOx sensor 330 or a first ammonia sensor 331, the at least one sensor 330, 331 positioned downstream of the at least one emission reduction device 329 being a second NOx sensor 330 or a second ammonia sensor 331. Further, optionally, exhaust system 103, 303 includes an ammonia injection device 332 configured for injecting ammonia into an exhaust stream. Further, optionally, exhaust system 103, 303 includes an oxygen sensor 328 for sensing oxygen in an exhaust stream in order to control or sense an air-fuel ratio. Further, optionally, exhaust system 103, 303 includes: (a) a Selective Catalytic Reduction catalyst (SCR) 120, 329A, and thus the exhaust system has an absence of Diesel Oxidation Catalyst (DOC) and a Diesel Particulate Filter (DPF); (b) an SCR 120, 329A, followed by an Ammonia Oxidation Catalyst (AMOX) 329E; (c) an SCR 120, 329A or an SCR/AMOX combination 329B, followed by a DOC 329C; (d) an SCR 120, 329A or an SCR/AMOX combination 329B, followed by a DOC 329C and then a DPF 329D; or (e) an N2O reduction catalyst 329F in any of (a)-(d) but after the SCR 120, 329A.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A compression ignition engine system, comprising:
a compression ignition engine, which is configured for using ammonia as a primary fuel source and a compression ignition engine fuel as a secondary fuel source; and
an exhaust system coupled with the compression ignition engine, the exhaust system having an absence of an exhaust gas recirculation system or an absence of an exhaust gas recirculation system that functions.

2. The compression ignition engine system according to claim 1, wherein the compression ignition engine system includes an intake conduit coupled with the compression ignition engine, wherein the ammonia is a liquid or a gas when the ammonia is introduced into the intake conduit.

3. The compression ignition engine system according to claim 1, further including a first structure configured for heating an intake air used by the compression ignition engine, wherein the first structure is a heat exchanger or an electric heater.

4. The compression ignition engine system according to claim 1, further including a second structure configured for modifying an air-fuel ratio, wherein the fuel includes the ammonia.

5. The compression ignition engine system according to claim 1, wherein the compression ignition engine system has an absence of an air-to-air charge air cooler or includes an air-to-air charge air cooler that is bypassed by a charge air.

6. The compression ignition engine system according to claim 1, wherein the exhaust system includes at least one emission reduction device and a plurality of sensors, the plurality of sensors including at least one sensor positioned upstream of the at least one emission reduction device and at least one sensor positioned downstream of the at least one emission reduction device, the at least one sensor positioned upstream of the at least one emission reduction device being a first NOx sensor or a first ammonia sensor, the at least one sensor positioned downstream of the at least one emission reduction device being a second NOx sensor or a second ammonia sensor.

7. The compression ignition engine system according to claim 1, wherein the exhaust system includes an ammonia injection device configured for injecting ammonia into an exhaust stream.

8. The compression ignition engine system according to claim 1, wherein the exhaust system includes an oxygen sensor for sensing oxygen in an exhaust stream in order to control or sense an air-fuel ratio.

9. The compression ignition engine system according to claim 1, wherein the exhaust system includes:
a. a Selective Catalytic Reduction catalyst (SCR), and thus the exhaust system has an absence of Diesel Oxidation Catalyst (DOC) and a Diesel Particulate Filter (DPF);
b. an SCR, followed by an Ammonia Oxidation Catalyst (AMOX);
c. an SCR or an SCR/AMOX combination, followed by a DOC;
d. an SCR or an SCR/AMOX combination, followed by a DOC and then a DPF; or
e. an N2O reduction catalyst in any of (a)-(d) but after the SCR.

10. A method of forming and using a compression ignition engine system, the method comprising the steps of:
providing that the compression ignition engine system includes a compression ignition engine, which is configured for using ammonia as a primary fuel source and a compression ignition engine fuel as a secondary fuel source; and
coupling an exhaust system with the compression ignition engine, the exhaust system having an absence of an exhaust gas recirculation system or an absence of an exhaust gas recirculation system that functions.

11. The method according to claim 10, wherein the compression ignition engine system includes an intake conduit coupled with the compression ignition engine, wherein the ammonia is a liquid or a gas when the ammonia is introduced into the intake conduit.

12. The method according to claim 10, wherein the compression ignition engine system further includes a first structure configured for heating an intake air used by the compression ignition engine, wherein the first structure is a heat exchanger or an electric heater.

13. The method according to claim 10, wherein the compression ignition engine system further includes a second structure configured for modifying an air-fuel ratio, wherein the fuel includes the ammonia.

14. The method according to claim 10, wherein the compression ignition engine system has an absence of an air-to-air charge air cooler or includes an air-to-air charge air cooler that is bypassed by a charge air.

15. The method according to claim 10, wherein the exhaust system includes at least one emission reduction device and a plurality of sensors, the plurality of sensors including at least one sensor positioned upstream of the at least one emission reduction device and at least one sensor positioned downstream of the at least one emission reduction device, the at least one sensor positioned upstream of the at least one emission reduction device being a first NOx sensor or a first ammonia sensor, the at least one sensor positioned downstream of the at least one emission reduction device being a second NOx sensor or a second ammonia sensor.

16. The method according to claim 10, wherein the exhaust system includes an ammonia injection device configured for injecting ammonia into an exhaust stream.

17. The method according to claim 10, wherein the exhaust system includes an oxygen sensor for sensing oxygen in an exhaust stream in order to control or sense an air-fuel ratio.

18. The method according to claim 10, wherein the exhaust system includes:
a. a Selective Catalytic Reduction catalyst (SCR), and thus the exhaust system has an absence of Diesel Oxidation Catalyst (DOC) and a Diesel Particulate Filter (DPF);
b. an SCR, followed by an Ammonia Oxidation Catalyst (AMOX);
c. an SCR or an SCR/AMOX combination, followed by a DOC;
d. an SCR or an SCR/AMOX combination, followed by a DOC and then a DPF; or
e. an N2O reduction catalyst in any of (a)-(d) but after the SCR.
